(19) United States
(12) Patent Application Publication
(10) Pub. No.: US 2022/0312794 A1
(43) Pub. Date: Oct. 6, 2022

(54) METHOD FOR PRODUCING LEGUMINOUS PROTEINS

(71) Applicant: ROQUETTE FRERES, Lestrem (FR)

(72) Inventors: Lucile CALMON, LILLE (FR); Aline LECOCQ, MOUVAUX (FR)

(21) Appl. No.: 17/596,869

(22) PCT Filed: Jun. 26, 2020
(86) PCT No.: PCT/FR2020/051122

§ 371 Date: Dec. 20, 2021

(30) Foreign Application Priority Data
Jun. 28, 2019 (FR) 19 07143

(51) Int. Cl. A23J 1/14; A23L 11/30; A23L 33/185

(52) U.S. Cl. CPC A23J 1/14; A23L 11/32; A23L 33/185; A23V 2002/00

(57) ABSTRACT

The invention falls within the field of plant proteins. The invention relates to, in particular, a method for producing a leguminous protein composition, preferably of peas, comprising a dry heat pre-treatment of leguminous seeds at a temperature between 70 and 130° C. for 1 to 6 minutes followed by grinding the seeds into flour, forming a suspension of the flour in an aqueous solution, separating the soluble components from the suspension and extracting proteins from said soluble components, as well as the protein composition that can be obtained by this method.

### TECHNICAL FIELD

The invention falls within the field of plant proteins. The invention concerns, in particular, a method for producing a leguminous plant protein composition, preferably from peas, and the protein composition obtainable by this method.

### BACKGROUND ART

Human daily requirements for proteins are between 12 and 20% of food intake. These proteins are supplied both by products of animal origin (meat, fish, eggs, dairy products) and by products of plant origin (cereals, leguminous plants, algae).

However, in developed countries, protein intake is predominantly in the form of proteins of animal origin. And yet, numerous studies show that excessive consumption of proteins of animal origin to the detriment of plant proteins is one of the causes of increases in cancer and cardiovascular diseases.

Moreover, animal proteins have many drawbacks, both in terms of their allergenicity, notably regarding proteins from milk or eggs, and in environmental terms, in connection with the harmful effects of intensive farming.

Thus, there is an increasing demand from manufacturers for compounds of plant origin having beneficial nutritional and functional properties without, however, having the disadvantages of compounds of animal origin.

Soybean has been, and still is, the main plant alternative to animal proteins. However, the use of soybean presents certain drawbacks. The origin of soybean seeds is more often than not from GMOs and the production of its protein proceeds via a de-oiling step which uses solvent.

Since the 1970s, the development of pulse plants, in particular including pea, in Europe and mainly in France, has dramatically increased as an alternative protein resource to animal proteins for animal and human food consumption. The pea contains approximately 27% by weight of protein substances. The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses). These seeds are non-GMO and do not require a de-oiling step using solvents.

Pea protein, predominantly pea globulin, has been extracted and utilized industrially for a great number of years. Mention may be made, as an example of a process for extracting pea protein, of patent EP1400537. In this process, the seed is milled in the absence of water (process referred to as “dry milling”) in order to obtain a flour. This flour will then be suspended in water in order to extract the protein therefrom.

Despite its undeniable qualities, the protein extracted from peas suffers, in comparison with animal proteins, from flavors known as “pea”, “beany” or “vegetable”. This flavor is an undeniable hindrance in many industrial applications, particularly food.

This is particularly the case in the field of beverages where the improvement of the organoleptic profile is essential because it is particularly difficult to mask the flavors of the protein: adding additional constituents can indeed result in a modification of the viscosity, the stability in solution and/or the palatability of the beverage. Furthermore, it is advantageous that the protein has a low gelling power or even a low viscosity, enabling an increase in the protein content without resulting in a beverage that does not gelate or is not too thick.

Following numerous studies, it has been clearly demonstrated that one of the main causes of these unwanted flavors comes from the synthesis of aldehydes and/or ketones (in particular hexanal) following the action of an internal lipoxygenase on the residual lipids during the extraction of the proteins. Saponins and 3-alkyl-2-methoxypyrazines are also classes of compounds generating these unwanted flavors (“Flavor aspects of pulse Ingredients”, Wibke S.U. Roland, 2017).

Persons skilled in the art have therefore developed several solutions to improve the flavor of a commercial pea protein and to give it a neutral taste. A first solution is based on masking the flavor by adding chemical compounds selected for this purpose: This solution compels the user to introduce into their formulation a compound that they did not necessarily want to introduce and that may be a source of regulatory and/or allergenic problems. Another solution is described in U.S. Pat. No. 4,022,919, which as early as the 1970s was teaching that treating said pea protein with steam makes it possible to obtain a protein the flavor of which is improved. Nevertheless, this method can be criticized for the risk of modifying the functional qualities of the proteins obtained by thermal denaturation (for example, the loss of solubility or the increase in its hydration capacity) as well as the obligation to add a purification step necessary before use. These solutions are therefore effective, but they require the end user of the proteins to carry out additional purification operations, which may alter the features of the pea protein. Persons skilled in the art have therefore obviously sought to obtain directly and simply during the extraction process a pea protein the flavor of which is neutral.

Many potential solutions have been explored, including but not limited to, the selection of pea cultivars with less lipoxygenase or the pre-sprouting of peas prior to protein extraction. More recently, we can cite patent application WO2017/120597 that discloses a method including precipitation by the addition of salts, multiple washings, and recovery by centrifugation. Despite a complex method using large amounts of water (up to 30 times the amount of pea), the “beany” and “bitter” flavors are still present in the pea protein (see graphs 18A, B and C of application WO2017/120597).

Since lipoxygenase and saponins are temperature sensitive, adding an additional heat treatment during the extraction step consisting of heating in a wet environment (blanching), possibly combined with a quenching step, was considered in WO 2019/053387. Unfortunately, these steps involve large quantities of water and generate soluble co-products that must be recovered. Moreover, the use of this method does not enable the production of proteins with reduced gelling power.

Roasting or dry heating (also called toasting) is used in the related soybean sector. An important issue for the pea sector is the preservation of pea starch, which must not be degraded in order to be used industrially. Soybeans do not contain starch; the soybean sector can therefore use very high heating temperatures to inhibit lipoxygenase without worrying about the starch issue.

Heating the seed can also cause functional modifications of the protein (for example solubility or emulsifying power), preventing certain uses, particularly in food.

It is therefore advantageous to obtain a leguminous plant protein, in particular a leguminous plant protein isolate, even more particularly a pea protein isolate, whose flavor is improved, while also presenting an optimized extraction method and guaranteed features.

### DISCLOSURE OF THE INVENTION

The inventors have shown that a preliminary step of heat treatment of the seeds at 70 to 130° C. for 1 to 6 minutes, advantageously at 100 to 120° C. for 2 to 4 minutes, made it possible to inhibit the activity of the internal lipoxygenase while preserving the functionality of the starch and guaranteeing the extraction yield of the various components. The method developed by the inventors makes it possible to obtain a leguminous plant protein composition whose functional properties are particularly suitable for protein-enriched beverage applications: improved organoleptic properties, reduced gelling power and improved emulsifying power.

According to a first aspect of the invention, a method is proposed for producing a leguminous plant protein composition comprising the following steps:

i) dry heat treatment of the leguminous plant seeds, preferably selected from the pea, lupin and faba bean at a temperature of 70 to 130° C., for example 80 to 125° C., especially 100° C. to 120° C., for 1 to 6 minutes, for example 1.5 to 5 minutes, especially 2 to 4 minutes;
ii) milling the seeds into flour and suspending the flour in an aqueous solution, preferably at a concentration of 15 to 25%, more preferably 20% by weight of dry matter with respect to the weight of the suspension,
(iii) separating the soluble components of said suspension by centrifugal force,
(iv) extracting proteins from the soluble components.

In a preferred embodiment, extracting the proteins from said fraction comprises a step of coagulating the proteins in an aqueous solution at a pH between 4 and 6 and heat-treating the solution between 45° C. and 65° C., preferably 55° C., in particular for 3.5 min to 4.5 min, preferably 4 min. Preferably, the coagulated proteins are recovered, preferably by centrifugation, and suspended in an aqueous solution. The pH of the aqueous solution of coagulated proteins can then be adjusted to between 6 and 8, preferably 7, and the aqueous suspension can be subjected to a heat treatment at 130 to 150° C., preferably 140° C. for 5 to 15 s, preferably 10 s. The method may further comprise a step of drying the aqueous suspension of the coagulated proteins.

According to another aspect, there is proposed a leguminous plant protein composition obtainable according to a method as described in the first aspect of said invention.

According to a final aspect of the invention, it is proposed that industrial uses, in particular for animal and human foodstuffs, be made of the protein composition obtainable by a method as described in the first aspect of said invention.

The invention will be better understood by virtue of the detailed description hereinbelow

### BRIEF DESCRIPTION OF THE DRAWINGS

FIG. 1 shows the viscosity analysis profile of protein compositions obtained by a method comprising heat treatment of the seeds for 4 min at 100° C. or 2 min at 120° C. or without heat treatment.

### DESCRIPTION OF THE EMBODIMENTS

According to a first aspect of the invention, a method is therefore proposed for producing a leguminous plant protein composition comprising the following steps:

i) heating the leguminous plant seeds, preferably selected from the pea, lupin and faba bean at a temperature of 70 to 130° C., for example 80 to 125° C., especially 100 to 120° C., for 1 to 6 minutes, for example 1.5 to 5 minutes, especially 2 to 4 minutes;
(ii) milling the seeds into flour and suspending it in an aqueous solution;
iii) separating the soluble components from said aqueous suspension, preferably by centrifugal force;
(iv) extracting the proteins in the soluble components.

The term “protein composition” should be understood in the present patent application as meaning a composition obtained by extraction and refining, said composition including proteins, macromolecules formed from one or more polypeptide chains consisting of a sequence of amino acid residues linked together via peptide bonds. In the particular context of pea proteins, the present invention relates more particularly to globulins (about 50-60% of the pea proteins). Pea globulins are mainly subdivided into three sub-families: legumins, vicilins and convicilins.

“Leguminous plants” will be understood in the present application to mean the family of dicotyledonous plants of the Fabales order. This is one of the largest flowering plant families, third after Orchidaceae and Asteraceae in terms of number of species. It contains approximately 765 genera, bringing together more than 19,500 species. Several leguminous plants are significant crop plants, such as soybean, beans, peas, chickpea, faba bean, groundnut, cultivated lentil, cultivated alfalfa, various clovers, broad beans, locust bean, liquorice and lupin.

According to a preferred mode of the invention, the leguminous plant protein is selected from the group consisting of the pea, bean, faba bean and mixtures thereof, preferably the pea.

The term “peas” includes in particular all wild varieties of “smooth peas” and all mutant varieties of “smooth peas” and “wrinkled peas”.

When the chosen leguminous plant is the pea, the peas can undergo, prior to the heating and milling stages of the method according to the invention, stages well-known to those skilled in the art, such as, in particular, cleaning (elimination of unwanted particles such as stones, dead insects, soil residues, etc.) and also dehulling of the external fibers at a temperature of between 70 and 130° C., for example between 80 and 125° C., especially between 100° C. and 120° C., for 1 to 6 minutes, for example 1.5 to 5 minutes, especially 2 to 4 minutes;

The method according to the invention comprises a step i) consisting of a heat treatment of the seeds at a temperature of between 70 and 130° C., for example between 80 and 125° C., especially between 100° C. and 120° C., for a time of 1 to 6 minutes, for example from 1.5 to 5 minutes, especially between 2 and 4 minutes. This heat treatment is a dry heat treatment, that is it takes place in the absence of an aqueous solvent additional to that present in the seed. This dry heat treatment, or toasting, differs from a microwave treatment in that the heat is supplied by convection, which allows precise control of the heat treatment of the seeds (time and temperature). This dry heat treatment is particularly advantageous because it can be carried out easily, without, for example, monitoring the relative humidity. As exemplified in the present application, it is important to respect the time and temperature intervals in order to be able to inhibit the activity of the internal lipoxygenase while preserving the functionality of the starch and guaranteeing the extraction yield of the various components.

Compliance with this heat treatment step prior to these particular conditions, as well as those of the various steps of this method, also makes it possible to obtain a protein composition whose functional properties are particularly suitable for protein-enriched beverage applications: improved organoleptic properties, reduced gelling power, and improved emulsifying power.

In an even more preferred embodiment, the temperature is between 110 and 120° C., for example 120° C. This choice makes it possible to obtain a very low viscosity of the protein composition, which is an additional advantage in certain food applications such as high-protein drinks.

This step optionally ends with the removal of the outer pea fibers (cellulosic outer shell) by a well known step also called “dehulling”.

The method according to the invention comprises a step ii) of milling the seeds and producing an aqueous suspension.

The milling is performed by any type of suitable technology known to those skilled in the art, such as with ball mills, conical mills, helical mills, jet mills or rotor/rotor systems.

During milling, water may be added in a continuous or discontinuous manner, at the start, during or at the end of milling, so as to produce at the end of the step an aqueous suspension of milled peas with between 15% and 25% by weight of solids (SC), preferentially 20% by weight of SC, relative to the weight of said suspension.

At the end of milling, the pH can be checked. Preferably, the pH of the aqueous suspension of milled peas at the end of step ii) is adjusted to between 8 and 10, preferably the pH is adjusted to 9. The pH may be adjusted by adding acid and/or base, for example sodium hydroxide or hydrochloric acid. The use of ascorbic acid, citric acid, potassium hydroxide and sodium hydroxide, are preferred.

The method according to the invention then consists of a step iii) of separating the soluble components from the aqueous suspension, preferably by centrifugal force. This step makes it possible to separate the soluble fractions from the insoluble fractions of the suspension. The insoluble fractions consist mainly of starch and of polysaccharides called “internal fibers”. The proteins are concentrated in the soluble fraction (supernatant).

Starch and fibers can also be separated by providing a first sieving step to remove the internal fibers of the pea. This first step is necessary because the internal fibers of the pea bind very easily to the starch and proteins of the pea. It is then necessary to multiply the washing of these fibers in order to extract the starch or the associated proteins. After this sieving stage, the suspension freed from internal fibers is centrifuged to generate a “light phase” containing mainly proteins, and a “heavy phase” containing mainly starch.

The method according to the invention comprises a step iv) of extracting the proteins from the soluble components. Said extraction may be carried out by any type of suitable method, such as, in particular, isoelectric pH precipitation of proteins or thermocoagulation by heating.

Preferentially, the extraction of the proteins consists of a step of coagulation of the proteins in an aqueous solution at a pH between 4 and 6, preferentially 5, followed by heating to a temperature between 45 and 65° C., preferentially 55° C.

The contact time may be between 1 min and 30 min, for example between 1 min and 10 min, preferentially between 3 min and 5 min, even more preferentially 5 min. The purpose herein is to separate the pea proteins of interest from the other constituents of the supernatant of step iv). It is very important to check the time/temperature scale.

Preferably, the heating is carried out by indirect steam injection, for example in a double-jacketed stirred tank.

The coagulated proteins, also known as coagulated protein floc, can then be recovered by centrifugation. The solid fractions with concentrated proteins are thus separated from the liquid fractions with concentrated sugars and salts. The floc is then suspended in an aqueous solution, preferably diluted with water. The solids content is then adjusted to between 10% and 20%, preferentially 15% by weight of solids relative to the weight of said suspension.

The pH of the protein floc can then be adjusted to a value between 6 and 8, preferentially 7. The pH is adjusted using any acidic and basic reagent(s). The use of ascorbic acid, citric acid, potassium hydroxide and sodium hydroxide, are preferred.

A heat treatment can then be carried out at 130° C. to 150° C., preferentially 140° C., for between 5 s and 15 s, preferentially 10 s.

The extraction of the proteins can preferentially conclude by drying using any technique known to those skilled in the art. In a preferred manner, the coagulated protein floc is dried to reach a solids content greater than 80%, preferentially greater than 90% by weight of proteins relative to the weight of said solids. To this end, any technique well known to those skilled in the art can be used, for instance freeze-drying or atomization. Atomization is the preferred technology, in particular multiple-effect atomization.

The solids content is measured by any method that is well known to those skilled in the art. Preferentially, the “desiccation” method is used. It consists in determining the amount of water evaporated by heating a known amount of a sample of known weight: The sample is first weighed and a mass m1 is measured in g; The water is evaporated off by placing the sample in a heated chamber until the sample mass has stabilized, the water being totally evaporated (preferably, the temperature is 105° C. under atmospheric pressure), the final sample is weighed and a mass m2 is measured in g. The solids content is obtained by the following calculation: (m2/m1)*100.

According to a second aspect of the invention, a leguminous plant protein composition is therefore proposed, in which the leguminous plant is chosen in particular from the pea, lupin and faba bean, which can be obtained according to a method as described in the first aspect of said invention.

In a preferential manner, the leguminous plant protein composition according to the invention has a protein content of greater than 80%, preferentially greater than 85%, even more preferentially greater than 90% by weight of proteins relative to the total weight of solids.

The protein content is measured by any technique well known to those skilled in the art. Preferably, the total nitrogen is assayed (as a weight percentage of nitrogen relative to the total dry weight of the composition) and the result is multiplied by a coefficient of 6.25. This well-known methodology in the field of plant proteins is based on the observation that proteins contain on average 16% nitrogen. Any dry matter assay method well known to those skilled in the art may also be used.

As exemplified below, the protein composition according to the invention is innovative because its organoleptic profile is improved, in particular the “vegetable” or “beany” component. This component is classically evaluated using an organoleptic tasting panel. This difference can also be characterized by analyzing the volatile compounds using gas chromatography equipped with a mass spectrophotometer.

This composition may also be characterized by an optimized gelling power, in that it is reduced by a factor of about 2 compared to a leguminous plant protein composition obtained by a production method not comprising a step of heat treatment of the leguminous plant seeds.

The term “gelling power” means the functional property which consists of the capacity of a protein composition for forming a gel or a network, which increases the viscosity and generates a state of matter between the liquid and solid states. The term “gel strength” may also be used. To quantify this gelling power, it is thus necessary to generate this network and to evaluate its strength. To perform this quantification, in the present invention, test A is used, the description of which is as follows:

1) Solubilization at 60° C.±2° C. of the protein composition tested in water at 15%+/−2% of solids and at pH 7;

### 2) Stirring for 5 min at 60° C.±2° C.;

3) Cooling to 20° C.±2° C. and stirring for 24 hours at 350 rpm;
4) Implementing the suspension with a controlled stress rheometer equipped with a concentric cylinder;
5) Implementing a following temperature profile:
a. Phase 1: heating from a temperature of 20° C.+/−2° C. to a temperature of 80° C.+/−2° C. in 10 minutes;
b. Phase 2: stabilization at a temperature of 80° C.+/−2° C. for 120 minutes;
c. Phase 3: cooling of a temperature from 80° C.+/−2° C. to a temperature of 20° C.+/−2° C. in 30 minutes
6) Measuring the gelling power expressed in Pa.

Preferably, the imposed stress rheometer is the TA Instruments AR 2000 model, equipped with a Duvet geometry and a Peltier temperature control system. In order to avoid evaporation problems at high temperature, liquid paraffin is added on top of the samples.

For the purposes of the invention, a “rheometer” is a laboratory machine for taking measurements regarding the rheology of a fluid or a gel. It applies a force to the sample. Generally of characteristic small dimensions (very small mechanical inertia of the rotor), it allows fundamental study of the mechanical properties of a liquid, a gel, a suspension, a paste, etc., in response to an applied force.

The so-called “controlled stress” models make it possible, by the application of a sinusoidal stress (oscillation mode), to determine the intrinsic viscoelastic values of matter, which notably are dependent upon time (or angular velocity ω) and upon temperature. In particular, this type of rheometer affords access to the complex modulus G*, which itself affords access to the moduli G′ or elastic part and G″ or viscous part.

This composition may also be characterized by an optimized emulsifying power, in that it is increased by a factor of about 2 compared to a leguminous plant protein composition obtained by a production method not comprising a step of heat treatment of the leguminous plant seeds.

“Emulsifying power” or also “emulsifying capacity” refers to the maximum amount of oil that can be dispersed in an aqueous solution containing a defined amount of emulsifier before the emulsion breaks or reverses phase (Sherman, 1995). In order to quantify it, the Applicant has developed a test to quantify it easily, quickly and reproducibly:
0.2 g of the product sample is dispersed in 20 mL of water,
The solution is homogenized with an Ultraturax IKA T25 for 30 sec at a speed of 9,500 rpm,
20 mL of corn oil is added under homogenization in the same conditions as step 2 above,
Centrifugation 5 minutes at 3,100 g,
If a good emulsion is obtained, repeat the test at point 1, increasing the quantities of water and corn by 50%,
If a bad emulsion is obtained (phase shift), repeat the test at point 1 reducing the quantities of water and corn by 50%,
The maximum amount of oil (Qmax in mL) that can be emulsified is thus determined iteratively,
The emulsifying capacity is therefore the maximum amount of corn oil that can be emulsified per grams of product,

Emulsifying capacity=(Qmax/0.2)*100

According to a last aspect of the invention, the industrial uses, in particular the animal feed and human food uses, of the leguminous plant protein composition, preferentially of the leguminous plant protein isolate, chosen from pea, lupin and faba bean, even more preferentially of the pea protein isolate according to the invention, are proposed.

As exemplified below, the protein compositions obtained by practicing the method according to the invention can be characterized by an improved organoleptic profile, a gel strength divided by at least a factor of 2 and an emulsifying power at least doubled in comparison with leguminous plant protein compositions obtained without heat treatment of the leguminous plant seeds. These characteristics are particularly suitable for protein-enriched beverages such as RTDs (“Ready To Drink”), vegetable-based milk alternatives, or Powder-mix drinks.

The improvement of the organoleptic profile is key for the end consumer, but the decrease in gelling power also enables an increase in the protein content without resulting in an overly thick drink. Finally, the emulsifying power is also of interest, for example to stabilize essential fatty acids

The invention will be better understood by means of the nonlimiting examples hereinbelow.

### EXAMPLES

### Example 1: Influence of the Heating Parameters of the Leguminous Plant Seeds in the Protein Production Method

For this example, we will use yellow pea seeds (Pisum Savitum) that have been cleaned and stripped of foreign matter such as pebbles.

Several heat treatment technologies are applied for comparative purposes:
Ventilated oven, 2 to 10 min, 80° to 120° C.
Microwave oven, 30 sec to 3 min, 1000 W
Autoclave, 5 to 15 min, 100° C. to 120° C.
   The following protein and starch extraction method is then applied:
Separating outer fibers and pea cotyledons
Grinding pea cotyledons with a stone mill
Suspending the flour in water at 17% solids content (SC), 20° C.+/−2° C. and pH of 7+/−1
Shaking for 30 min
Separating the insolubles (starch and internal fibers) by centrifugation 1,000 G 5 min,
Rectifying the supernatant at pH 5
Heating to 55° C. for 20 min in a vessel equipped with a double jacket and stirring,
Recovering the protein composition by centrifugation 5,000 G 5 min
Rectifying the pH to 7 with 1N NaOH
Heat-treating by direct injection 140° C. 10 seconds
Spray drying
   Several measurements are taken to qualify and compare the different methods:
Denaturation state of the starch by DSC and enthalpy measurement
Calculation of the protein recovery yield (Amount of protein extracted/amount of total protein).
Flavor by tasting. This component is evaluated using an organoleptic tasting panel.

The results are presented in Table 1 below:

TABLE 1

| Samples | Flavor | Starch quality | Protein yield |
|---|---|---|---|
| Ventilated oven/80° C./ | burnt | Ok | Ok |
| 10-60 min | | | |
| Ventilated oven/120° C./ | burnt+ | Ok | Average |
| 10-60 min | | | |
| Ventilated oven/150° C./ | burnt++ | Ok | Bad |
| 10-60 min | | | |
| Ventilated oven/80° C./ | ok | Ok | Ok |
| 2 min | | | |
| Ventilated oven/80° C./ | ok | Ok | Ok |
| 5 min | | | |
| Ventilated oven/120° C./ | Ok | Ok | Ok |
| 2 min | | | |
| Ventilated oven/120° C./ | Ok | Ok | ok |
| 5 min | | | |
| autoclaving/5 min/120° C. | pea | Ok | Ok |
| autoclaving /10 min/ | pea | Ok | ok |
| 110° C. | | | |
| autoclaving/15 min/ | Pea+ | Ok | ok |
| 100° C. | | | |
| microwave/1:30 min | burnt+/ | ok | ok |
| | bitter+ | | |
| microwave/3 min | burnt++/ | ok | ok |
| | bitter++ | | |
| microwave/30 s | pea | ok | ok |
| microwave/60 s | burnt | ok | ok |
| microwave/90 s | Burnt+ | ok | ok |

Pre-treatment by dry-heating makes it possible to improve the flavor of the proteins obtained while preserving the functionality of the starch and guaranteeing the extraction yield of the various components.

### Example 2: Examples to Demonstrate the Effect of Dry Heat Treatment on the Quality of the Resulting Protein Composition

The purpose of this example is to demonstrate the effect of a dry heat treatment on the quality of the protein composition obtained.
Three seed pre-treatments are studied:
   a. No pre-treatment
   b. Ventilated oven 4 min 100° C.
   b. Ventilated oven 2 min 120° C.
Separating outer fibers and pea cotyledons
Grinding pea cotyledons with a stone mill
Suspending the flour in water at 17% SC, 20° C.+/−2° C. and pH of 7+/−1
Shaking for 30 min
Separating the insolubles (starch and internal fibers) by centrifugation 1,000 G 5 min
Rectifying the supernatant at pH 5
Heating to 55° C. for 20 min in a vessel equipped with a double jacket and stirring
Recovering the protein composition by centrifugation 5,000 G 5 min
Rectifying the pH to 7 with 1N NaOH
Heat-treating by direct injection 140° C. 10 seconds
Spray-drying.

Several measurements are taken to qualify and compare the different tests:
Solids content measured by drying.
Protein content calculated by measuring the total nitrogen and multiplying the result by a coefficient of 6.25
Protein recovery yield (amount of protein extracted/total protein amount)
Emulsifying activity measured by the test developed by the Applicant described above.
Gel strength measured by Test A as described above.

The results are presented in Table 2 below:

TABLE 2

| | | | | “Emulsifying | Gel |
|---|---|---|---|---|---|
| | | N6.25 | Yield | activity | strength |
| | SC (%) | (%) | (%) | (mL oil/g)” | (Pa) |
| No pre- | 96.4 | 91.3 | 72.2 | 250 | 104 |
| treatment | | | | | |
| Ventilated | 94.2 | 90.4 | 71.9 | 450 | 31 |
| oven/4 min/ | | | | | |
| 100° C. | | | | | |
| Ventilated | 97 | 91.1 | 74 | 550 | 51 |
| oven/2 min/ | | | | | |
| 120° C. | | | | | |

The protein compositions according to the invention have a nearly doubled emulsifying capacity and a reduced gel strength.

The viscosity of the protein compositions are measured using a TA Instrument AR 2000 rheometer equipped with a Duvet geometry and a Peltier temperature control system. The measurement is performed at a temperature of 20° C. and a shear rate of 0.006 at 600 s-1 in 3 min.

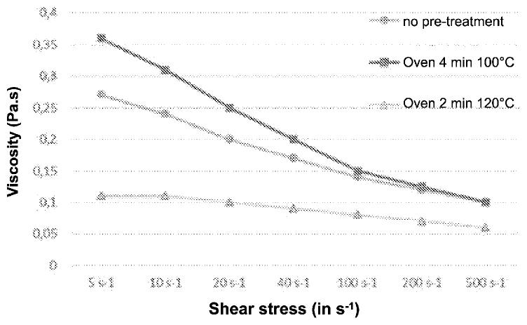

The protein composition according to the invention made at a temperature of 120° C. also has a lower viscosity (FIG. 1).

Furthermore, a method similar to the method for the production of the protein composition a. (the one obtained without pretreatment) is carried out, by replacing the grinding of the pea cotyledons using a stone mill with wet grinding of the pea cotyledons as described in WO 2019/053387 in Example 1. This grinding consists in putting the pea cotyledons in an aqueous solution at 80° C., heat-treating them for 3 minutes while maintaining the temperature of said solution, recovering and then cooling them to 10° C. by immersing them in water regulated at 7° C., and then grinding them in solution. At the end of the method, a comparative protein composition is obtained that has a gel strength that is not diminished in comparison with the protein composition a.

1-9. (canceled)

10. A method for producing a leguminous protein composition comprising the following steps:
i) dry heat treatment of leguminous plant seeds at a temperature of 70 to 130° C., for example 80 to 125° C., especially 100 to 120° C., for 1 to 6 minutes, for example 1.5 to 5 minutes, especially 2 to 4 minutes;
ii) milling the seeds into flour and suspending the flour in an aqueous solution;
iii) separating the soluble components of said suspension preferably by centrifugal force;
iv) extracting proteins from said soluble components.

11. The method according to claim 10, wherein the flour in step ii) is put in an aqueous suspension at a concentration of 15 to 25% by weight of solids, preferably 20% by weight of solids relative to the weight of the suspension.

12. The method according to claim 10, wherein step iv) of extracting proteins comprises the step of:
coagulating the proteins in an aqueous solution at a pH between 4 and 6 and heat treatment of the solution between 45° C. and 65° C., preferably 55° C.

13. The method according to claim 12, further comprising the steps of:
recovering the coagulated proteins, preferably by centrifugation and suspension of the proteins in an aqueous solution;
adjusting the pH of the aqueous protein solution to between 6 and 8, preferably 7;
heat-treating the aqueous protein solution at 130° C. to 150° C., preferentially 140° C., for 5 s to 15 s, preferably 10 s.

14. The method according to claim 10, further comprising a step of drying the aqueous suspension of the proteins.

15. The method of production according to claim 10, wherein the leguminous plant seeds are selected from the pea, lupin and faba bean.

16. The method of production according to claim 15, wherein the leguminous plant seeds are pea seeds.

17. A leguminous plant protein composition obtainable by a method of production according to claim 10.

18. A use of a leguminous plant protein according to claim 10 in the production of foodstuffs.
